(19) United States
(12) Patent Application Publication
(10) Pub. No.: US 2026/0225949 A1
(43) Pub. Date: Aug. 6, 2026

(54) METHOD FOR PROCESSING CERAMIC SUBSTRATE AND CERAMIC SUBSTRATE

(71) Applicant: NIPPON ELECTRIC GLASS CO., LTD., Shiga (JP)

(72) Inventor: Mitsuyoshi TAKUSARI, Shiga (JP)

(21) Appl. No.: 18/706,682

(22) PCT Filed: Oct. 24, 2022
(86) PCT No.: PCT/JP2022/039508

§ 371 Date: Mar. 27, 2026

(30) Foreign Application Priority Data
Nov. 12, 2021 (JP) 2021-184981

(51) Int. Cl. C03C 23/00; C03C 4/00; C03C 10/00

(52) U.S. Cl. CPC C03C 23/0025; C03C 4/0071; C03C 10/0054

(57) ABSTRACT

A ceramic substrate 111 has a ceramic part 112 containing Al₂O₃. A method for processing the ceramic substrate 111 comprises an irradiation step in which a portion of the main surface of the ceramic part 112 is irradiated with laser light LB. A colored portion is formed in the irradiation step of this method for processing the ceramic substrate 111.

### TECHNICAL FIELD

The present invention relates to a method for processing a ceramic substrate and a ceramic substrate.

### BACKGROUND ART

Patent Literature 1 discloses an example of a ceramic substrate including glass and used as a ceramic wiring substrate or the like. Further, Patent Literature 2 discloses a substrate that includes an alignment mark used for positioning.

### CITATION LIST

### Patent Literature

Patent Literature 1: Japanese Laid-Open Patent Publication No. 2015-092541
Patent Literature 2: Japanese Laid-Open Patent Publication No. 2006-330192

### SUMMARY OF INVENTION

### Technical Problem

The present invention allows for easy formation of a colored portion on a ceramic substrate. An objective of the present invention is to provide a method for processing a ceramic substrate and a ceramic substrate that easily form a colored portion on the ceramic substrate.

### Solution to Problem

A method for processing a ceramic substrate that solves the above problem is a method for processing a ceramic substrate including a ceramic portion containing Al₂O₃. The method includes an emission step of emitting a laser beam toward a part of a main surface of the ceramic portion. The emission step forms a colored portion.

In the above method, the emission step may form the colored portion by coloring the part of the main surface using Al in the ceramic substrate.

In the above method, the ceramic portion may further contain TiO₂. The colored portion may contain Ti³⁺ produced in the emission step.

In the above method, the ceramic portion may be glass ceramic containing glass. The glass ceramic may have a composition of 20 to 70 mass % of glass, 10 to 60 mass % of Al₂O₃, and 20 to 70 mass % of Zn₂SiO₄.

In the above method, the ceramic portion may be glass ceramic containing glass. The glass ceramic may have a composition of 30 to 70 mass % of glass and 30 to 70 mass % of Al₂O₃.

In the above method, the glass may have a glass composition of 50 to 80 mass % of SiO₂, 10 to 30 mass % of B₂O₃, 1 to 10 mass % of Li₂O+Na₂O+K₂0, 5 to 30 mass % of MgO+CaO+SrO+BaO, and 0 to 10 mass % of TiO₂.

In the above method, the ceramic substrate may further include an alignment mark arranged on the ceramic portion. The emission step may emit the laser beam toward the ceramic portion adjacent to the alignment mark so that the colored portion is formed adjacent to the alignment mark.

In the above method, the laser beam may be a UV laser beam. The emission step may form the colored portion including irregularities.

A ceramic substrate containing Al₂O₃ includes a ceramic portion, an alignment mark arranged on the ceramic portion, and a colored portion that differs in color from the ceramic portion. The colored portion is formed in a region adjacent to the alignment mark.

In the above ceramic substrate, the color of the colored portion may result from Al.

In the above ceramic substrate, the ceramic portion may be glass ceramic containing glass. The glass ceramic may have a composition of 20 to 70 mass % of glass, 10 to 60 mass % of Al₂O₃, and 20 to 70 mass % of Zn₂SiO₄.

In the above ceramic substrate, the ceramic portion may be glass ceramic containing glass. The glass ceramic may have a composition of 30 to 70 mass % of glass and 30 to 70 mass % of Al₂O₃.

In the above ceramic substrate, the glass may have a glass composition of 50 to 80 mass % of SiO₂, 10 to 30 mass % of B₂03, 1 to 10 mass % of Li₂O+Na₂O+K₂0, 5 to 30 mass % of MgO+CaO+SrO+BaO, and 0 to 10 mass % of TiO₂.

In the above ceramic substrate, the colored portion may have an arithmetic mean surface roughness Ra in a range of 0.5 μm to 15 μm.

In the above ceramic substrate, the colored portion may have a surface roughness of which a maximum height Sz is in a range of 5 μm to 40 μm.

In the above ceramic substrate, the ceramic portion excluding the colored portion may have an arithmetic mean surface roughness Ra in a range of 5 nm to 35 nm.

A ceramic substrate includes a ceramic portion containing Al₂O₃, and a colored portion that differs in color from the ceramic portion. The colored portion is colored using Al in the ceramic substrate.

### Advantageous Effects of Invention

The present invention easily forms the colored portion on the ceramic substrate.

### BRIEF DESCRIPTION OF DRAWINGS

FIG. 1 is a plan view of a ceramic substrate in accordance with an embodiment.

FIG. 2 is a cross-sectional view taken along line 2-2 of FIG. 1.

FIG. 3 is a cross-sectional view illustrating a method for processing the ceramic substrate.

FIG. 4 is an ESR spectrum of the ceramic substrate prior to an emission step.

FIG. 5 is an ESR spectrum of the ceramic substrate subsequent to the emission step.

### DESCRIPTION OF EMBODIMENT

An embodiment of a method for processing a ceramic substrate and a ceramic substrate will now be described with reference to the drawings. To facilitate understanding, some of the elements may be illustrated in an exaggerated or simplified manner in the drawings. Further, elements in the drawings may not be to scale. First, a ceramic substrate processed by the method for processing a ceramic substrate will be described.

### Ceramic Substrate

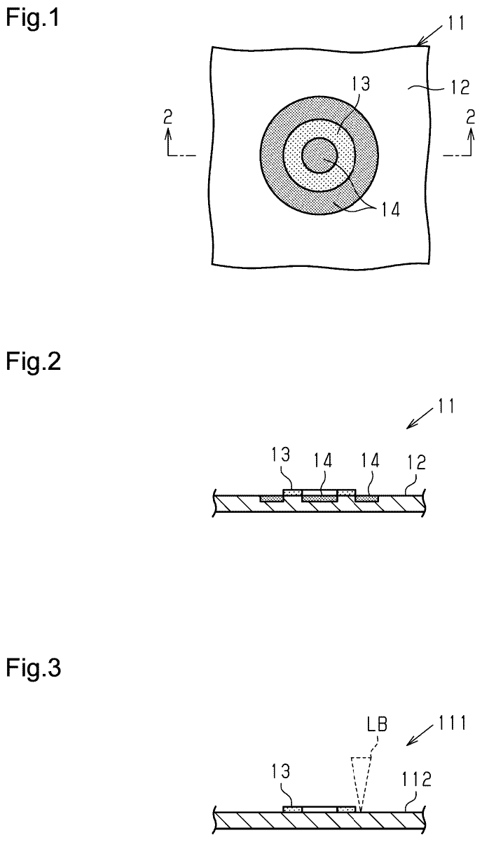

As shown in FIGS. 1 and 2, a ceramic substrate 11 includes a ceramic portion 12, an alignment mark 13, and a colored portion 14. The ceramic portion 12 contains Al₂O₃. The alignment mark 13 is arranged on the ceramic portion 12. The colored portion 14 differs in color from the ceramic portion 12. The colored portion 14 is formed in a region adjacent to the alignment mark 13.

### Ceramic Portion

Preferably, the ceramic portion 12 of the ceramic substrate 11 is formed from glass ceramic or ceramic. Glass ceramic contains glass and ceramic. An example of the glass ceramic is low temperature co-fired ceramic (LTCC).

Preferably, the glass has a glass composition of 50 to 80 mass % of SiO₂, 10 to 30 mass % of B₂O₃, 1 to 10 mass % of Li₂O+Na₂O+K₂O, 5 to 30 mass % of MgO+CaO+SrO+BaO, and 0 to 10 mass % of TiO₂; more preferably, 60 to 80 mass % of SiO₂, 10 to 30 mass % of B₂O₃, 1 to 5 mass % of Li₂O+Na₂O+K₂O, 5 to 20 mass % of MgO+CaO+SrO+BaO, and 0.1 to 3 mass % of TiO₂. The glass composition may contain 0.1 to 3 mass % of ZrO₂ as other oxides.

Examples of the ceramic include Zn₂SiO₄ (willemite), Al₂O₃ (alumina), cordierite, AlN (aluminum nitride), a zirconium phosphate-based compound, ZrSiO₄ (zircon), ZrO₂ (zirconia), TiO₂ (titanium oxide), tin oxide (SnO₂), β-quartz solid solution, β-eucryptite, β-spodumene, and the like. The ceramic may be of one type or a combination of two or more types.

Preferably, the glass ceramic has a composition of 20 to 70 mass % of glass, 10 to 60 mass % of Al₂O₃, and 20 to 70 mass % of Zn₂SiO₄; more preferably, 30 to 60 mass % of glass, 15 to 45 mass % of Al₂O₃, and 25 to 55 mass % of Zn₂SiO₄; further preferably, 35 to 50 mass % of glass, 20 to 35 mass % of Al₂O₃, and 30 to 45 mass % of Zn₂SiO₄.

The glass ceramic composition does not have to contain Zn₂SiO₄. Preferably, the glass ceramic has a composition of 30 to 70 mass % of glass and 30 to 70 mass % of Al₂O₃; more preferably, 40 to 60 mass % of glass and 40 to 60 mass % of Al₂O₃; further preferably, 45 to 55 mass % of glass and 45 to 55 mass % of Al₂O₃.

The ceramic portion 12 may be, for example, obtained by a known method in which a green sheet of ceramic is used to form a circuit pattern. Preferably, the ceramic portion 12 has a main surface that is polished. More preferably, the main surface of the ceramic portion 12 is mirror polished. In this case, the ceramic portion 12 does not have scratches and unevenness that would be transferred to a multilayer film, including a plating film, a polyimide film, and the like, arranged on the ceramic portion 12. If scratches and unevenness of the ceramic portion were transferred to the multilayer film, the appearance of the multilayer film would be adversely affected.

The main surface of the ceramic portion 12 is polished, for example, using bonded abrasive grains or loose abrasive grains. Preferably, the ceramic portion 12 excluding the colored portion 14 has an arithmetic mean roughness Ra in a range of 5 nm to 35 nm.

### Alignment Mark

The alignment mark 13 of the ceramic substrate 11 may be formed from, for example, metal. The metal material of the alignment mark 13 may be, for example, Au, Ag, Ni, Cr, or the like. The shape of the alignment mark 13 is not particularly specified. The alignment mark 13 may be, for example, circular, quadrilateral, cross-shaped, or the like. Further, the alignment mark 13 may have the form of a circular ring, an elliptical ring, a rectangular frame, or the like. The alignment mark 13 may be a combination of shapes. The alignment mark 13 may be, for example, formed by plating, printing, or the like.

### Colored Portion

Preferably, the colored portion 14 of the ceramic substrate 11 has a color resulting from Al. The colored portion 14 has, for example, a gray color resulting from Al. The colored portion 14 may contain Ti³⁺. Preferably, the colored portion 14 has an arithmetic mean roughness Ra in a range of 0.5 μm to 15 μm. Preferably, the colored portion 14 has a surface roughness of which the maximum height Sz is in a range of 5 μm to 40 μm. The colored portion 14 is formed on the surface of the ceramic portion 12. Preferably, the colored portion 14 has, for example, a thickness in a range of 1 μm to 15 μm.

### Method for Processing Ceramic Substrate

The method for processing the ceramic substrate will now be described.

As shown in FIG. 3, a ceramic substrate 111 includes a ceramic portion 112 that contains Al₂O₃. The method for processing the ceramic substrate 111 includes an emission step of emitting a laser beam LB toward a part of the main surface of the ceramic portion 112 of the ceramic substrate 111. In the method for processing the ceramic substrate 111, the emission step forms the colored portion 14 shown in FIGS. 1 and 2.

The emission step may form the colored portion 14 by coloring a part of the main surface of the ceramic portion 112 using Al in the ceramic substrate. Specifically, the laser beam LB alters the part of the main surface of the ceramic portion 112 so that the colored portion 14 is formed. The ceramic portion 112 may further contain TiO₂, and the colored portion 14 may contain Ti³⁺ produced in the emission step. The TiO₂ contained in the ceramic portion 112 may be included in either the ceramic composition or the glass composition.

In the present embodiment, the emission step emits the laser beam LB toward the ceramic portion 112 adjacent to the alignment mark 13 so that the colored portion 14 is formed adjacent to the alignment mark 13.

The emission step emits, for example, a UV laser beam, a green laser beam, or the like. Preferably, the laser beam LB is a UV laser beam. Examples of the UV laser beam include an yttrium aluminum garnet (YAG) laser, an excimer laser, and the like.

Preferably, the laser beam LB is, for example, emitted at an average output in a range of 0.5 W to 15 W. Preferably, the laser beam LB has, for example, a frequency in a range of 40 kHz to 300 kHz. Preferably, the laser beam LB has, for example, a focal diameter in a range of 5 μm to 30 μm.

A method for scanning the laser beam LB is not particularly specified. For example, the laser beam LB is scanned along a first straight scanning target line and then a second straight scanning target line that extends parallel to the first scanning target line. A predetermined range on the surface of the ceramic portion 112 is irradiated with the laser beam LB through repetition of such scanning.

Preferably, the interval between two adjacent scanning target lines, or the pitch width is, for example, in a range of 10% to 150% of the focal diameter. Preferably, the laser beam LB is, for example, scanned at a speed in a range of 25 mm/s to 500 mm/s.

The emission step, for example, may use a UV laser beam to form the colored portion 14 having irregularities. For example, the colored portion 14 having irregularities has the arithmetic mean roughness Ra or the maximum height Sz described under “Colored Portion” section.

### Prototype Example

A prototype example will now be described.

First, the ceramic substrate 111 (LTCC substrate, glass ceramic substrate) was prepared. The glass ceramic had a composition of 50 mass % of glass, 25 mass % of Al₂O₃, and 25 mass % of Zn₂SiO₄.

The glass had a composition of 60 mass % of SiO₂, 20 mass % of B₂O₃, 2 mass % of Na₂O, 2 mass % of K₂O, 3 mass % of MgO, 10 mass % of CaO, 1 mass % of BaO, 1 mass % of TiO₂, and 1 mass % of ZrO₂.

The main surface of the ceramic substrate 111 was mirror polished. The main surface of the ceramic substrate 111 included the alignment mark 13 (external dimension: 500 μm). The alignment mark 13 was formed by Au plating.

Then, the emission step was performed to emit the laser beam LB toward the ceramic portion 112 of the ceramic substrate 111. In the emission step of the present prototype example, as shown in FIG. 3, the laser beam LB was emitted toward the inner side of the alignment mark 13 and along the outer circumference of the alignment mark 13. This formed the colored portion 14 in the regions adjacent to the alignment mark 13.

The laser beam LB was emitted under the following conditions.
Laser LB type: UV-laser, wavelength 355 nm
Average output: 2 W
Frequency: 90 kHz
Focal diameter: 20 μm

In the emission step, the laser beam LB was scanned along a first straight scanning target line, and then a second straight scanning target line extending parallel to the first scanning target line. Such scanning of the laser beam LB was repeated until the predetermined range on the surface of the ceramic portion 112 was irradiated with the laser beam LB. The interval between two adjacent scanning target lines, or the pitch width, was set to 10 μm. The laser beam LB was scanned at a speed of 100 mm/s.

### Observation Result of Sample by Microscope

The surfaces of the alignment mark 13, the ceramic portion 12, and the colored portion 14 of a sample obtained from the prototype example were observed using a microscope in a state illuminated with a white incident light. The alignment mark 13 had a substantially white color. The ceramic portion 12 had a gray color. The colored portion 14 had a black color.

This result shows that the alignment mark 13 is easy to identify when the alignment mark 13 is adjacent to the colored portion 14 than when the alignment mark 13 is adjacent to the ceramic portion 12. That is, the colored portion 14 formed in a region adjacent to the alignment mark 13 improves the identifiability of the alignment mark 13.

### Analysis of Colored Portion by Electron Spin Resonance (ESR) Method

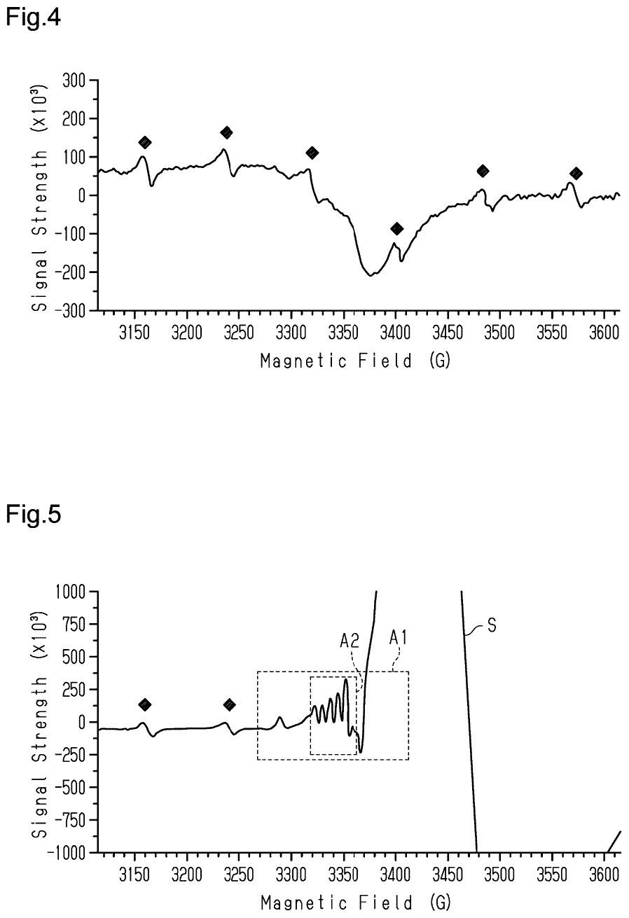

First, electron spin resonance (ESR) measurement was performed on the main surface of the ceramic portion 112 of the ceramic substrate 111 at a measurement temperature of 50 K to obtain an ESR spectrum. The ceramic substrate 111 used in the above prototype example had not undergone the emission step. The result is shown in FIG. 4.

Next, ESR measurement was performed on the main surface of the colored portion 14 of the ceramic substrate 11 at a measurement temperature of 50 K to obtain an ESR spectrum. The ceramic substrate 11 obtained in the above prototype example had undergone the emission step. The result is shown in FIG. 5.

The symbols “♦” (solid diamond) shown in FIGS. 4 and 5 represent where six lines centered at g=2.002 appeared (division interval: approximately 82 G, Mn²⁺). In the ESR spectrum shown in FIG. 5, a signal based on multiple types of electron holes (g=2.050, 2.010, 2.002) appeared in region A1 indicated by the broken lines. Further, in the ESR spectrum shown in FIG. 5, a six-line signal centered at g=2.018 was present in region A2 indicated by the broken lines. In this manner, the ESR spectrum shown in FIG. 5 included the six-line signal centered at g=2.018, which was not present in the ESR spectrum shown in FIG. 4. The six-line signal centered at g=2.018 is a resonance signal based on A1. More specifically, it is understood that the six-line signal is a signal resulting from nuclear spins of ²⁷Al.

These results indicate that the colored portion 14 on the ceramic substrate 11 subsequent to the emission step was colored using Al contained in the ceramic portion 112 of the ceramic substrate 111 prior to the emission step. Thus, the colored portion 14 was colored due to the change in the structure including Al. Further, the signal centered at g=2.018 observed at the colored portion 14 is greater than g=2.0023 of free electron. Accordingly, it can be presumed that the signal centered at g=2.018 observed at the colored portion 14 was caused by electron holes having Al. Therefore, in order to form the colored portion 14 in the emission step, the ceramic substrate 111 needs to contain an A1 source, that is, Al₂O₃, prior to the emission step.

In the ESR spectrum shown in FIG. 5, signal S is a resonance signal at g=1.946 caused by Ti. It is understood that the resonance signal at g=1.946 had a peak resulting from lattice defect due to oxygen vacancy. This result indicates that Ti³⁺ also contributed to coloring of the colored portion 14.

Table 1 shows the observation results of the colored portion 14 using the ESR spectrum.

TABLE 1

| | Quantitative Value (number/g) | | |
|---|---|---|---|
| | | Six Lines Centered at | g = 2.050, |
| | | g = 2.018 (Division | 2.010, 2.002 |
| | g = 1.946 | Interval: 7 G) | Electron Hole |
| | Ti³⁺ | Electron Hole Having Al | (Unclassified) |
| Ceramic Portion | Not Observed | Not Observed | Not Observed |
| Colored Portion | 8.10E + 17 | 5.50E + 14 | 1.60E + 15 |

### Measurement of Surface State

The ceramic portion 112 of the ceramic substrate 111 prior to the emission step was measured for an arithmetic mean surface roughness Ra and a maximum height Sz ofthe surface roughness with a surface roughness measuring apparatus (SURFCOM 1400D manufactured by TOKYO SEIMITSU CO., LTD.) and a laser microscope (OLS5000 manufactured by Olympus Corporation).

The colored portion 14 of the ceramic substrate 11 subsequent to the emission step was also measured for an arithmetic mean surface roughness Ra and a maximum height Sz of the surface roughness in the same manner. The results are shown in Table 2.

TABLE 2

| | Arithmetic Average | |
|---|---|---|
| | Roughness Ra | Maximum Height Sz |
| Ceramic Portion | 10 to 30 nm | 1 to 2 μm |
| Colored Portion | 1.5 to 1.6 μm | 11 to 13 μm |

When the alignment mark 13 is formed by, for example, plating, the alignment mark 13 has a relatively smooth surface. In this case, the colored portion 14 adjacent to the alignment mark 13 has greater values of Ra and Sz than the ceramic portion 112 so that the alignment mark 13 is easy to identify.

The operation and advantages of the present embodiment will now be described.

(1) The method for processing the ceramic substrate 111, which includes the ceramic portion 112 containing Al₂O₃, includes the emission step of emitting the laser beam LB toward a part of the main surface of the ceramic portion 112. In the method for processing the ceramic substrate 111, the emission step forms the colored portion 14. This method easily forms the colored portion 14 in the emission step of emitting the laser beam LB using the ceramic portion 112, which contains Al₂O₃. For example, the colored portion 14 allows identification information to be readily added to the ceramic substrate 111.

(2) In the method for processing the ceramic substrate 111, the ceramic portion 112 may further contain TiO₂, and the colored portion 14 may contain Ti³⁺ produced in the emission step. In this case, the tone of the colored portion 14 can be changed.

(3) In the method for processing the ceramic substrate 111, the ceramic substrate 111 further includes the alignment mark 13 arranged on the ceramic portion 112. The emission step emits the laser beam LB toward the ceramic portion 112 adjacent to the alignment mark 13 to form the colored portion 14 adjacent to the alignment mark 13. In this case, even when the alignment mark 13 adjacent to the ceramic portion 112 is difficult to identify, for example, the colored portion 14 formed adjacent to the alignment mark 13 improves the identifiability of the alignment mark 13.

When the main surface of the ceramic portion 112 is mirror polished and the alignment mark 13 is metal-plated, for example, light is easily reflected by the main surface of the ceramic portion 112 and the main surface of the alignment mark 13. This particularly lowers the identifiability of the alignment mark 13 relative to the ceramic portion 112. The colored portion 14 is especially advantageous in improving the identifiability of such an alignment mark 13.

(4) The laser beam LB emitted in the emission step may be a UV laser beam, and the emission step may form the colored portion 14 having irregularities. In this case, for example, the tone of the colored portion 14 can be changed with the light scattered by the irregularities of the colored portion 14.

(5) The ceramic substrate 11 may be, for example, used as a ceramic wiring substrate; particularly, a substrate used in a semiconductor inspection device such as a probe card. Further, the ceramic substrate 11 may be used as a motherboard for manufacturing multiple packages of electronic components, that is, a motherboard for obtaining multiple substrates. For example, these applications require high precision positioning. Thus, it is particularly effective to improve the identifiability of the alignment mark 13 as described above.

### Modified Examples

The above embodiment may be modified as follows. The above embodiment and the following modifications can be combined as long as the combined modifications remain technically consistent with each other.

The method for processing the ceramic substrate 111 may be changed to a processing method that forms the colored portion 14 at a position not adjacent to the alignment mark 13. Further, the method for processing the ceramic substrate 111 may be changed to a processing method that forms the colored portion 14 on the ceramic substrate having no alignment mark 13. In this case, the colored portion 14 may be configured as a display portion that shows identification information such as text, numbers, symbols, and the like. In other words, with this method for processing the ceramic substrate 111, the colored portion 14 allows identification information to be readily added to the ceramic substrate 111. The obtained ceramic substrate 11 includes the ceramic portion 12 containing Al₂O₃ and the colored portion 14 differing in color from the ceramic portion 12. Further, the colored portion 14 is colored using Al in the ceramic substrate.

The alignment mark 13 of the ceramic substrate 111 may be arranged at one position on the ceramic portion 112 or multiple positions on the ceramic portion 112. When the alignment mark 13 is arranged at multiple positions on the ceramic portion 112, the colored portion 14 of the ceramic substrate 11 may be formed in a region adjacent to at least one of the alignment marks 13.

### REFERENCE SIGNS LIST

11) ceramic substrate (after emission step), 12) ceramic portion (after emission step), 13) alignment mark, 14) colored portion, 111) ceramic substrate (before emission step), 112) ceramic portion (before emission step), LB) laser beam

1. A method for processing a ceramic substrate including a ceramic portion containing Al₂O₃, the method comprising:
an emission step of emitting a laser beam toward a part of a main surface of the ceramic portion,
wherein the emission step forms a colored portion.

2. The method according to claim 1, wherein the emission step forms the colored portion by coloring the part of the main surface using Al in the ceramic substrate.

3. The method according to claim 1, wherein
the ceramic portion further contains TiO₂, and
the colored portion contains Ti³⁺ produced in the emission step.

4. The method according to claim 1 or 2, wherein
the ceramic portion is glass ceramic containing glass, and
the glass ceramic has a composition of 20 to 70 mass % of glass, 10 to 60 mass % of Al₂O₃, and 20 to 70 mass % of Zn₂SiO₄.

5. The method according to claim 1 or 2, wherein
the ceramic portion is glass ceramic containing glass, and
the glass ceramic has a composition of 30 to 70 mass % of glass and 30 to 70 mass % of Al₂O₃.

6. The method according to claim 4 or 5, wherein the glass has a glass composition of 50 to 80 mass % of SiO₂, 10 to 30 mass % of B₂O₃, 1 to 10 mass % of Li₂O+Na₂O+K₂O, 5 to 30 mass % of MgO+CaO+SrO+BaO, and 0 to 10 mass % of TiO₂.

7. The method according to any one of claims 1 to 6, wherein
the ceramic substrate further includes an alignment mark arranged on the ceramic portion, and
the emission step emits the laser beam toward the ceramic portion adjacent to the alignment mark so that the colored portion is formed adjacent to the alignment mark.

8. The method according to any one of claims 1 to 7, wherein
the laser beam is a UV laser beam, and
the emission step forms the colored portion including irregularities.

9. A ceramic substrate, comprising:
a ceramic portion containing Al₂O₃;
an alignment mark arranged on the ceramic portion; and
a colored portion that differs in color from the ceramic portion, wherein
the colored portion is formed in a region adjacent to the alignment mark.

10. The ceramic substrate according to claim 9, wherein the color of the colored portion results from Al.

11. The ceramic substrate according to claim 9 or 10, wherein
the ceramic portion is glass ceramic containing glass, and
the glass ceramic has a composition of 20 to 70 mass % of glass, 10 to 60 mass % of Al₂O₃, and 20 to 70 mass % of Zn₂SiO₄.

12. The ceramic substrate according to claim 9 or 10, wherein
the ceramic portion is glass ceramic containing glass, and
the glass ceramic has a composition of 30 to 70 mass % of glass and 30 to 70 mass % of Al₂O₃.

13. The ceramic substrate according to claim 11 or 12, wherein the glass has a glass composition of 50 to 80 mass % of SiO₂, 10 to 30 mass % of B₂O₃, 1 to 10 mass % of Li₂O+Na₂O+K₂O, 5 to 30 mass % of MgO+CaO+SrO+BaO, and 0 to 10 mass % of TiO₂.

14. The ceramic substrate according to any one of claims 9 to 13, wherein the colored portion has an arithmetic mean surface roughness Ra in a range of 0.5 μm to 15 μm.

15. The ceramic substrate according to any one of claims 9 to 14, wherein the colored portion has a surface roughness of which a maximum height Sz is in a range of 5 μm to 40 μm.

16. The ceramic substrate according to any one of claims 9 to 15, wherein the ceramic portion excluding the colored portion has an arithmetic mean surface roughness Ra in a range of 5 nm to 35 nm.

17. A ceramic substrate, comprising:
a ceramic portion containing Al₂O₃; and
a colored portion that differs in color from the ceramic portion, wherein
the colored portion is colored using Al in the ceramic substrate.
